(19) United States
(12) Patent Application Publication
(10) Pub. No.: US 2010/0096850 A1
(43) Pub. Date: Apr. 22, 2010

(54) Nanostructured alloy coated threaded metal surfaces and methods of producing same

(75) Inventors: Christopher A. Schuh, Ashland, MA (US); Pablo A. Castro, Buenos Aires (AR)

Correspondence Address: STEVEN J WEISSBURG, 190 WALDEN STREET, 3RD FLOOR, CAMBRIDGE, MA, 02140, US

(73) Assignee: Massachusetts Institute of Technology, Cambridge, MA (US)

(21) Appl. No.: 11/590,241

(22) Filed: Oct. 31, 2006

(51) Int. Cl. F16L 25/00; F16B 39/00; C25C 1/00

(52) U.S. Cl. 285/333; 411/81; 204/547

(57) ABSTRACT

A method for protecting a threaded metal joint from galling and corrosion includes providing a nanocrystalline coating on the metal surface. The nanocrystalline coating can include a solid or liquid lubricant to protect against wear. Threaded metal joint surfaces coated with the nanocrystalline coating can resist galling under high pressure and high torque, even after several fastening and unfastening operations and also over a long period of time. Protection from corrosion is also provided by the nanocrystalline coating. The method and nanocrystalline coating provide metal surfaces with both lubrication and protection against corrosion. Problems such as removal or leakage, which are associated with protective compounds that use oils, are avoided. The nanocrystalline coatings may be layers of the same material, or layers of differing materials, such as layers with lubricating particles dispersed throughout, and layers without lubricating particles. Such coatings may provide reduced wear, friction, corrosion and galling. Such coated threaded articles are very useful in messy and dirty environments, such as oil production and oil handling industries.

Objects of inventions hereof will be better understood with reference to the detailed description, the claims and the Figures of the Drawing, which are:

### BRIEF DESCRIPTION OF THE FIGURES OF THE DRAWING

FIG. 1, is a digital scanning electron microscope (SEM) image of a cross-section of a Ni—W alloy surface deposited by pulse plating;

FIG. 2 is a graphical representation showing friction coefficient on the vertical axis vs. time in seconds on the horizontal axis for a Ni—W deposit, ball-on-disc test;

FIG. 3 is a digital SEM image of a Ni—W+MoS₂ co-deposit, detected using backscattered electrons in the image on the left, and secondary electrons on the right;

FIG. 4 is a digital SEM image of a cross-section of a Ni—W+MoS₂ co-deposit such as shown in FIG. 3;

FIG. 5 is a digital image of an energy dispersive spectroscopy (EDS) mapping, of a cross-section of a Ni—W+MoS₂ co-deposit such as shown in FIG. 3;

FIG. 6 is a digital SEM image of a Ni—W/Ni—W+MoS₂ co-deposit;

FIG. 7 is a digital SEM image of a cross-section of a Ni—W/Ni—W+MoS₂ co-deposit such as shown in FIG. 6, detected using backscattered electrons in the image shown on the left, and secondary electrons on the right;

FIG. 8 is a digital SEM image showing surface morphology of a Ni—W/Ni—W+MoS₂/Ni—W co-deposit;

FIG. 9 is a digital SEM image of a cross-section of a Ni—W/Ni—W+MoS₂/Ni—W co-deposit such as shown in FIG. 8;

FIG. 10 is a graphical representation showing friction coefficient on the vertical axis vs. time in seconds on the horizontal axis for a Ni—W/Ni—W+MoS₂/Ni—W co-deposit, ball-on-disc test;

FIG. 11 is a digital SEM image of a Ni—W+graphite co-deposit, detected using backscattered electrons on the left, and secondary electrons on the right;

FIG. 12 is a digital SEM image of a cross-section of a Ni—W+graphite co-deposit such as shown in FIG. 11;

FIG. 13 is a digital SEM image of a Ni—W and PTFE co-deposit, showing the surface morphology;

FIG. 14 is a digital SEM image of a cross-section of a Ni—W and PTFE co-deposit;

FIG. 15 is a graphical representation showing friction coefficient on the vertical axis vs. time in seconds on the horizontal axis for a Ni—W and PTFE co-deposit, ball-on-disc test;

FIG. 16 shows schematically a layout for a ring on disk test, including the ring and disk, electric motor and torque load cell; and

FIG. 17 shows a detail of the ring and disk of FIG. 16.

### DISCUSSION

Inventions disclosed herein relate to lubrication of metal surfaces and protecting them from corrosion. Some inventions relate more particularly to methods of protecting a metal surface, such as the surface of threaded joints in oil tubing or casings, by depositing a nanostructured alloy, such as Ni—W, or other, on the thread surface. Inventions disclosed herein also relate to a composition for protecting a metal surface from galling and corrosion. Inventions disclosed herein also protect metal surfaces from wear. Threaded surfaces used in the oil industry benefit particularly from inventions disclosed herein.

Lubricants and Galling Protection. Galling is a form of surface damage arising between sliding solid surfaces, such as the threaded connections of oil pipe joints, distinguished by macroscopic, usually localized, roughening and raising of protrusions above the original surface. Galling often includes plastic flow or material transfer, or both. A number of known surface treatments protect metal surfaces from galling.

One known method uses a coating including a layer of oil-containing rust inhibitors. This coating is applied to a threaded joint, over a coating of dry lubricant, and must be removed in the oil field before assembling the connection, thus complicating operations.

Another idea provides a threaded joint having high galling resistance. A resin coating layer in which at least one powder selected from the group consisting of molybdenum disulfide and tungsten disulfide is dispersed and mixed. The resin layer is formed on, and has a thickness larger than, a phosphate chemical formation coating layer.

Another technique uses a surface treatment on threaded pipe connections, including a first uniform layer of a dry corrosion-inhibiting coating and a second uniform layer of a dry lubricant coating applied over the first layer. It also discloses a uniform layer of dry corrosion inhibiting coating that contains a dispersion of particles of solid lubricant.

Another known scheme treats a threaded joint for steel pipes which comprises a pin and a box, each having a contact surface including a threaded portion and an unthreaded metal contact portion and which guarantees galling resistance and gas tightness in a stable manner, without application of a compound grease. A solid lubricating coating comprising a lubricating powder (e.g., molybdenum disulfide) and an organic or inorganic binder is formed on the contact surface of at least one of the pin and the box. The proportion of area of a cross section along the thickness of the solid lubricating coating which is occupied by secondary particles of the lubricating powder having an equivalent circular diameter of 15-60 μm is from 5-90%. Alternatively, the solid lubricating coating comprises, in addition to the lubricating powder, a fibrous filler (e.g., inorganic whiskers) in such an amount that the mass ratio of the fibrous filler to the binder is 0.01-0.5. As a result, galling resistance is improved, particularly at high temperatures.

One last example of a known method is for a tubular member having an internal and/or external metal thread at one end thereof, at least part of the thread being coated with an alloy of copper and tin, having improved galling resistance.

### OBJECTS

Therefore, it is an object hereof to provide protection from galling to metal surfaces, particularly threaded joint surfaces, such as in oil tubing and casing used in the oil industry, subjected to high pressure, high friction, and/or high torque conditions.

It is another object to provide both galling-protection and corrosion-protection to metal surfaces without using any coating or application that must be removed before use. It is another object to provide protection from galling and/or corrosion that does not require maintaining on the threads, a coating that is messy, or to which dirt and contaminants will readily adhere. It is yet another object to provide protection that lasts for a very large number of thread engagements without need to reapply any protective material. Still another object is to provide such a protective layer that is not a liquid. Another object of an invention hereof is to provide a protection that does not require modification of the mechanical engagement of threads. Yet another object of an invention hereof is to provide a coating that protects a metal surface from wear, alone, or in addition to protection from galling, corrosion and friction.

### DETAILED DESCRIPTION

As used herein, a functional surface treatment is one that provides anti-galling, anti-corrosion, anti-wear, or lubrication, either individually, or in combination. Surface protection can be achieved by electrochemical deposition onto a threaded metal surface of alloys with nanoscale grain sizes such as Ni—W or other alloys. It has been discovered that a nanostructured alloy deposited on the surface of the threaded parts imparts a high galling resistance and a barrier to corrosion. Rather than Ni—W alloys, other metal systems can be used.

Nanocrystalline Ni—W alloys may be constituted, prepared, and deposited according to various methods, such as those described by Detor and Schuh in U.S. Ser. No. 11/147,146, filed on Jun. 7, 2005, entitled METHOD FOR PRODUCING ALLOY DEPOSITS AND CONTROLLING THE NANOSTRUCTURE THEREOF USING NEGATIVE CURRENT PULSING ELECTRO-DEPOSITION, AND ARTICLES INCORPORATING SUCH DEPOSITS, Attorney Docket No. MIT 11353 US, the full disclosure of which is fully incorporated herein by reference.

An invention described herein relates to composition, preparation, and application of nanocrystalline alloys to threaded steel and other metal surfaces, such as the surface of a threaded joint in an oil pipe, to protect the metal against galling under high applied torque, or to confer resistance to corrosion, or both. As one example, the underlying metal of the thread can be steel and the nanocrystalline coating alloy can be Ni—W. This is an example only, and should not be taken to be limiting.

Additives may be included in the nanocrystalline coating to enhance properties such as anti-corrosive properties, lubrication, or surface finish. The properties of the nanocrystalline coating film surface can also be modified by post-chemical or mechanical treatment.

An added lubricant is not necessary in the nanocrystalline coating. By itself a nanocrystalline Ni—W alloy coating has a very low friction coefficient that provides lubrication or anti-galling properties and also provides a barrier against corrosion and protects against wear.

Nevertheless, sliding performance of some nanocrystalline coatings can be improved by the use of lubricants. The lubricants can be either solid or liquid and can be co-deposited together with the nanocrystalline coating or applied on top of it. Such lubricants include, but are not limited to molybdenum disulfide, graphite, or mixtures thereof. Another candidate is solid lubricant (such as polytetraflouroethylene, sold by DuPont Denemours & Co., under the trade name Teflon®, or graphite, which may be added to the solution. Continuous stirring during the addition may be beneficial.

An invention disclosed in Detor et al. is to use the shape of the applied current waveform to control the grain size and composition of a deposit. The following discussion is taken from Detor et al. By introducing a bipolar wave current, for instance a square wave with both positive and negative current portions, the nanocrystalline grain size can be precisely controlled for electrodeposited alloys of two or more chemical components. Along with this precise control, the deposited metal also exhibits superior macroscopic quality, necessary for most practical applications of the material.

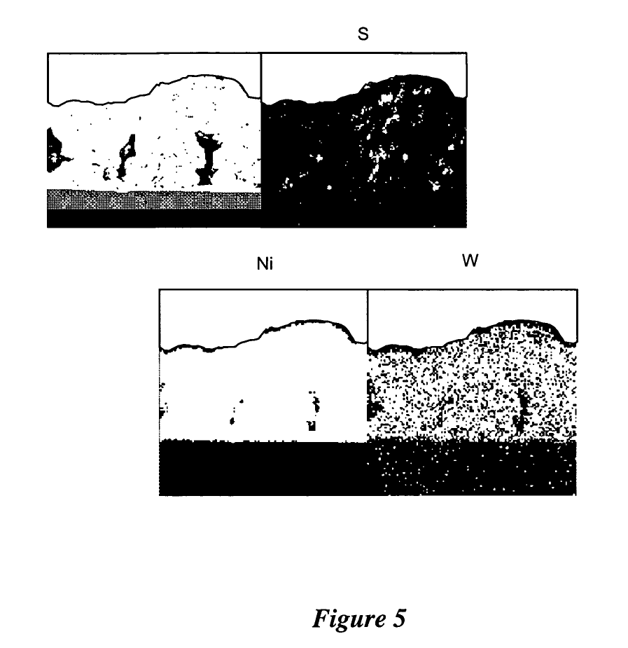

An invention thereof is to use bipolar pulsed current (BPP). With BPP, shown schematically in FIG. 5 of Detor et al., current is pulsed with a positive current 5P segment, alternated with a negative current 5N segment, where the potential is momentarily inverted so that the element 340, which is a nominal cathode when current is positive, becomes an anode and vice versa. The opposite occurs with the electrode 342, which is a nominal anode during positive current, and a cathode during negative current. There need be no extended “off-time,” (current of zero) although, there may be a momentary “off-time”, and, more importantly, there is a definite period of negative current. Typically, the characteristic pulse times tₚₒₛ, t_{neg} are on the order of 0.1-100 millisecond. There could also be a definite and measurable off-time of zero current, for instance using a pulse that has a positive period, a zero period and a negative period, and the positive or zero again.

The presence of a negative current during t_{neg} has several important effects. During the negative portion of the pulse, typically the atoms with the highest oxidation potential (lowest reduction potential) of the alloy, will be selectively etched (dissolved) from the deposit. This selective etching occurs regarding the most electro-active element, whether it is metal or not. This selective dissolution allows for precise control (within useful limits) of composition of the deposit with respect to the electro-active element. Other things being kept equal, as the absolute value of the amplitude of the negative pulse current increases, there is a resulting decrease in the proportion in the deposit of the more electro-active element.

The Detor et al. inventors teach that a ratio Q of two components of the exciting waveform can be used to control composition of the deposit, and thus its grain size. These components are the absolute value of the time integrated amplitude of negative polarity current (I⁻), and the absolute value of time integrated amplitude of positive polarity current (I⁺), where:

$$\begin{matrix}N = \vert \int {I}^{-} ( t ) d t \vert & Eq . 1 \\ P = \vert \int {I}^{+} ( t ) d t \vert and & Eq . 2 \\ Q = \frac{N}{P} , & Eq . 3\end{matrix}$$

where t is time, and the integrals in Eq. 1 and Eq. 2, run over all periods of negative and positive current, respectively. As used herein in the specification and the claims, the quantity Q is called the Polarity Ratio. The Polarity Ratio is always positive, because it is defined in terms of the absolute values of the amplitudes of the pulse components. In general, the Polarity Ratio will be greater than zero, and less than 1, for reasons discussed below.

In the most general case, control of the grain size of a deposition of a metallic object requires a few things. An electrodeposition system must co-deposit two or more elements simultaneously, at least one of which is a metallic element. The metallic element may, but need not be the most electro-active element.

The value of the Polarity Ratio can be varied by varying the amplitude and/or duration of both the positive and the negative pulses, relative to each other.

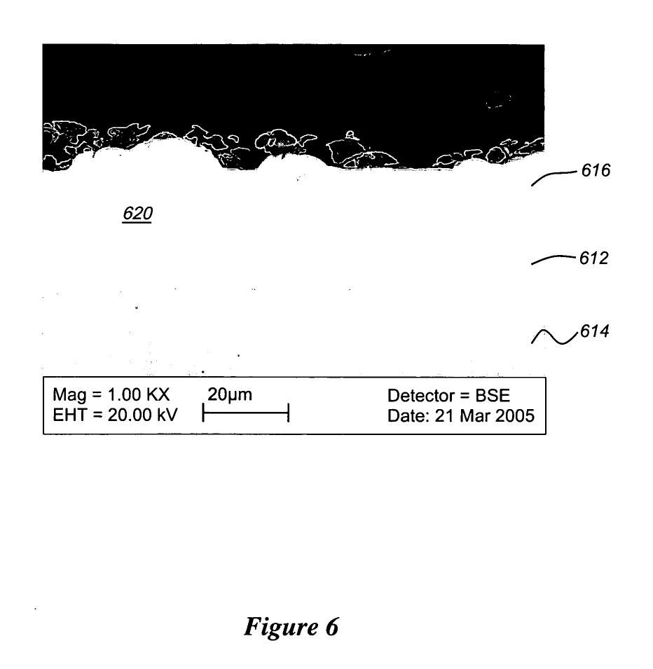

FIG. 6 of Detor et al., is a graph showing schematically a generic relationship between the composition of a deposit, as characterized by the atomic % (at %) of the electro-active element (on the vertical scale) as a function of Polarity Ratio (on the horizontal scale).

In this specification and in the claims hereof, the contribution of the electro-active element to the composition will be referred to as the proportion of the electro-active element. The proportion can be measured in any appropriate way, including but not limited to: parts, weight percent, atomic percent, weight fractions, atomic fractions, volume percent or volume fraction, or any appropriate division.

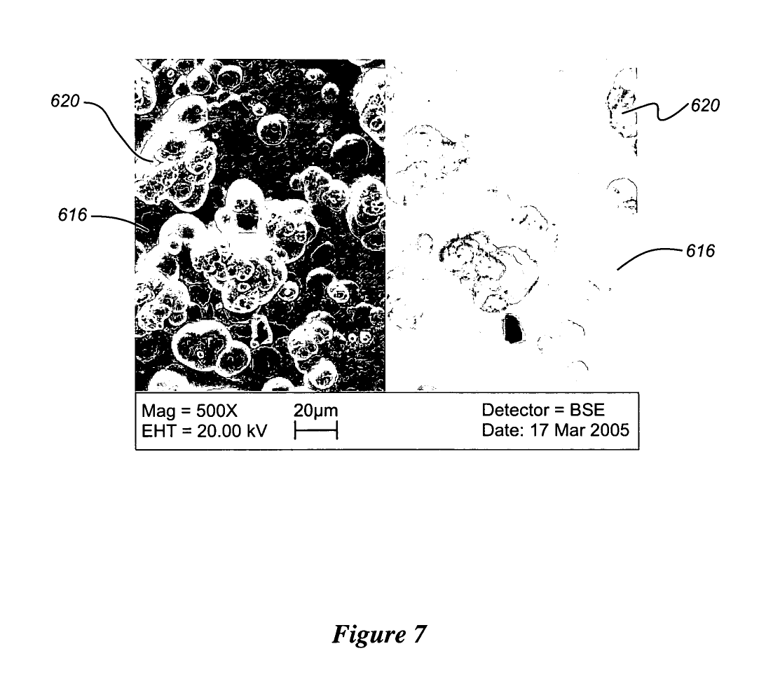

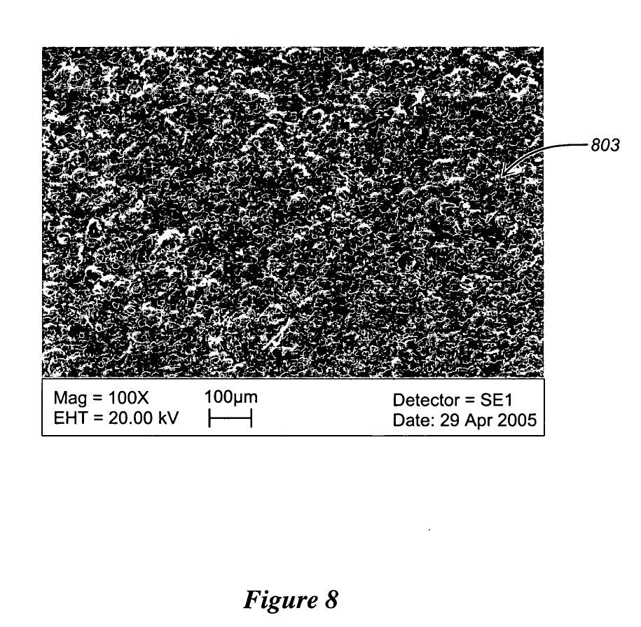

In some alloy systems, there is a clear relationship between electro-deposit composition, as characterized by proportion of electro-active element, and grain size. For instance, as shown in FIG. 7 of Detor et al., as the proportion of the electro-active element increases, the grain size decreases. But, in general, a relatively larger proportion of the electro-active element could result in either a relative smaller grain size, or relatively larger grain size (as shown schematically in FIG. 8 of Detor et al., discussed below).

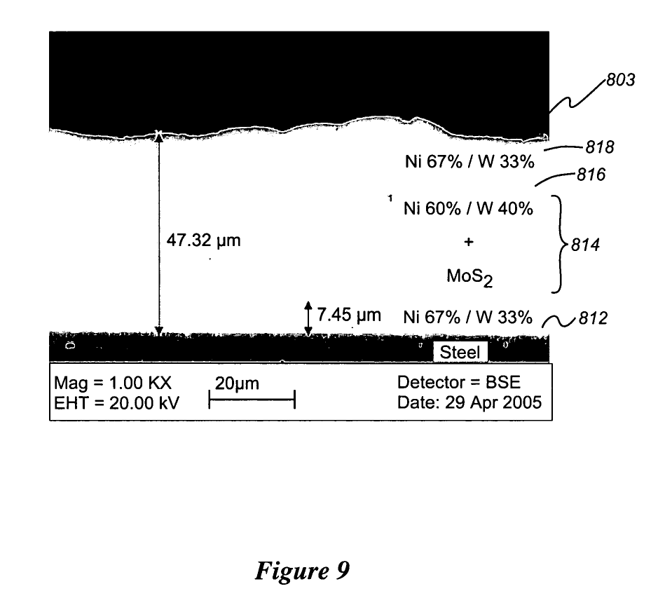

In general, this disclosure discussion is based on generic, or representative graphical representations of the relationships among parameters. For instance, Detor et al., FIGS. 6, 7, 8, 11, 16 represent generic relations. Several figures are based on experimental work by the inventors thereof, typically with the Ni—W system, for instance, Detor et al., FIGS. 9, 10, 14, 15.

FIG. 7 of Detor et al. shows grain size as a function of proportion of the electro-active element. An important point is that grain size can be precisely controlled through careful adjustment to the composition in general, and in particular, of the proportion of the electro-active element. A reasonably full explanation is given in Weissmuller, J., Alloy effects in nanostructures, Nanostructured Materials, 1993, 3, p. 261-72, the disclosure of which is fully incorporated herein by reference.

Thus, Detor et al. FIG. 7 shows schematically that proportion of electro-active element can be used to control deposit grain size.

Because, as discussed above, there is also generally a dependence of proportion of electro-active element upon Polarity Ratio, it is an invention of Detor et al., to use BPP in electrodeposition of alloys, to precisely control Polarity Ratio and thus, composition, with respect to electro-active element proportion, and by controlling composition, thereby to robustly control nanocrystalline grain size.

The method of using a Detor et al. alloy system and electrodepositing works as follows. The system is driven by a power supply to provide periods of both a positive current and a negative current at different times as specified by the system designer, which corresponds to a specific, single Polarity Ratio. This in turn results in a specific deposit composition which has a proportion of the electro-active element that will achieve the specified grain size. Thus, the specified grain size is achieved. Thus, to design a system, a constitutive relation is required, relating grain size to Polarity Ratio. To run the system, only a single point, relating a single average grain size to a single Polarity Ratio is required, or used.

Bipolar pulsing has been reduced to practice in the Ni—W system. It is also widely applicable to other electrodeposited, multi-component systems that show a relationship between composition and grain size, including but not limited to: nickel-molybdenum (Ni—Mo); nickel-phosphorous (Ni—P); nickel-tungsten-boron (Ni—W—B); iron-molybdenum (Fe—Mo); iron-phosphorous (Fe—P); cobalt-molybdenum (Co—Mo); cobalt-phosphorous (Co—P); cobalt-zinc (Co—Zn); iron-tungsten (Fe—W); copper-silver (Cu—Ag); cobalt-nickel-phosphorous (Co—Ni—P); cobalt-tungsten (Co—W); and chromium-phosphorous (Cr—P).

In general, the foregoing has discussed changing the Polarity Ratio by changing the amplitude of the negative pulse component. It is also possible to change the Polarity Ratio to achieve similar results by changing the duration of the negative pulse (t_{neg}) relative to the duration of the positive pulse tₚₒₛ, instead of changing only the negative current density amplitude, as was done above. Further, both the duration and the amplitude can be changed. It is also possible to alter the shape of the positive and negative pulses, such that they are no longer square waves as illustrated schematically in FIG. 5. The important quantification of the negative pulsing is the Polarity Ratio.

The nanocrystalline coating need not include additives to help achieve protection against galling, wear and corrosion. However, additives, such as dispersing agents for the solid lubricants, encapsulating polymers, etc., may be beneficial. Other agents that may be beneficial include a complementary inhibitor, such as zinc, to improve corrosion resistance.

Rather than using the techniques described in Detor above, a nanocrystalline coating may be applied to metal surfaces by any plating method for deposition of alloys known to the art that will plate a nano-crystalline coating.

The nanocrystalline coating may be applied onto a bare metal surface such as iron, steel, brass, zinc, or stainless steel. It can also be applied, for example, onto a copper layer or other alloy or metal previously deposited onto a metal surface. When one of the surfaces involved in a joint or in a friction couple (known as a “pin and box” in the oil industry, or as “male” and “female” threaded components more generally) is chemically pretreated by manganese phosphate, higher galling resistance has been observed.

In one embodiment of an invention hereof, a functional nanocrystalline coating is applied to the surface of a box (that is, the internal, female threaded end of a connection). The corresponding pin (that is, the external, male threaded end of a connection) is pre-treated with manganese phosphate, to provide additional corrosion protection to the pin-and-box couple. The pin also may or may not have a nano-crystalline coating.

Methods and functional nanocrystalline coatings of inventions disclosed herein are further illustrated in the following examples, which are illustrative only and are not to be considered to be limiting in any way.

A typical nano-crystalline electrodeposition solution can contain NiSO₄, Na₂WO₄, Sodium Citrate and NH₄Cl. The relative amounts are as set forth in Detor Table 1.

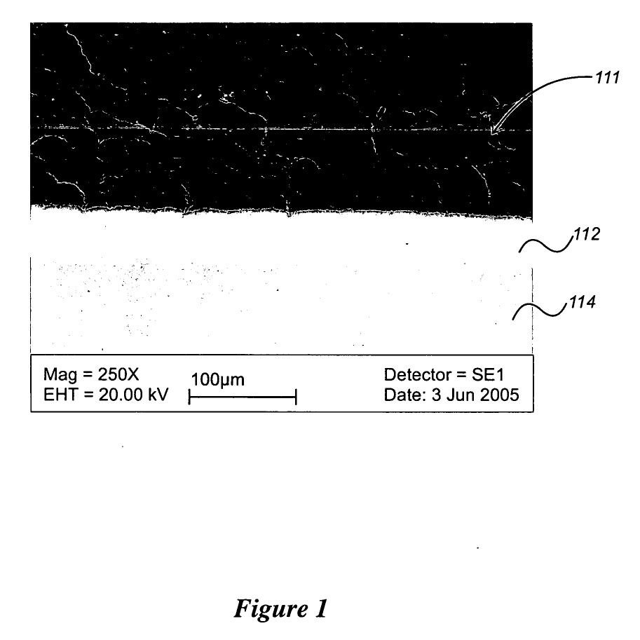

FIG. 1 shows a typical nanostructured Ni—W deposit 112 on carbon steel 114 base.

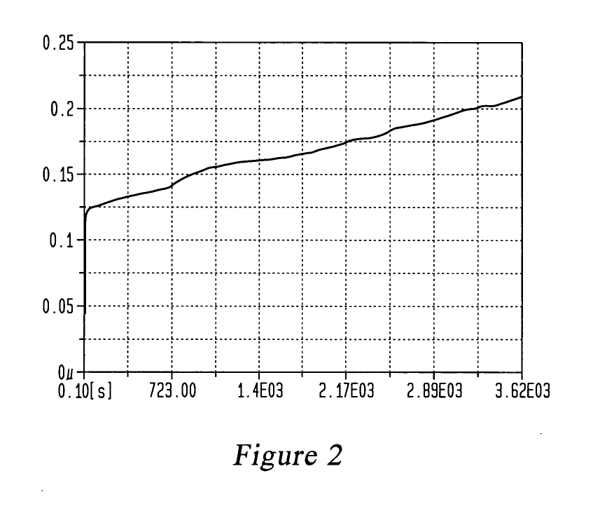

The results of a ball-on-disc test are shown graphically with reference to FIG. 2. This test is a common method of assessing friction and wear, in which a counterbody ball is held in sliding contact with a disc of material. The friction coefficient is found from the ratio of lateral sliding force to applied normal force on the ball. In the present case the disc was coated by nanocrystalline Ni—W. Deposits generated by the technique described above exhibit a friction coefficient of from 0.12 to 0.2 (FIG. 2). Lower friction coefficients are expected for smoother coatings which can be produced by a stronger stirring of the solution, for example. Smoother coatings may also be produced through judicious choice of temperature, deposition conditions, or through the use of additives in the chemical bath.

Co-deposition of lubricant particles. Co-deposition of lubricant particles may also be conducted. The co-deposition method can be used to modify the properties of the coating by incorporating lubricants into the metal matrix itself. This provides self-lubrication even as the coating wears out.

Lubricant particles were dispersed into the plating solution described above in a separate series of experiments. In some cases a dispersive agent was used to maintain the particles in suspension. The solid lubricants used include: MoS₂, graphite and PTFE (Teflon®). In some cases a multilayer strategy alternating layers of the nanostructured metal with and without the lubricant was followed.

Co-deposition of MoS₂ particles and Ni—W. Up to 20 g of MoS₂ powder was mixed with one liter of Ni—W plating solution as described above. Adding the powder slowly while stirring prevents agglomerations. During plating, stirring the solution thoroughly prevents precipitation of the lubricant.

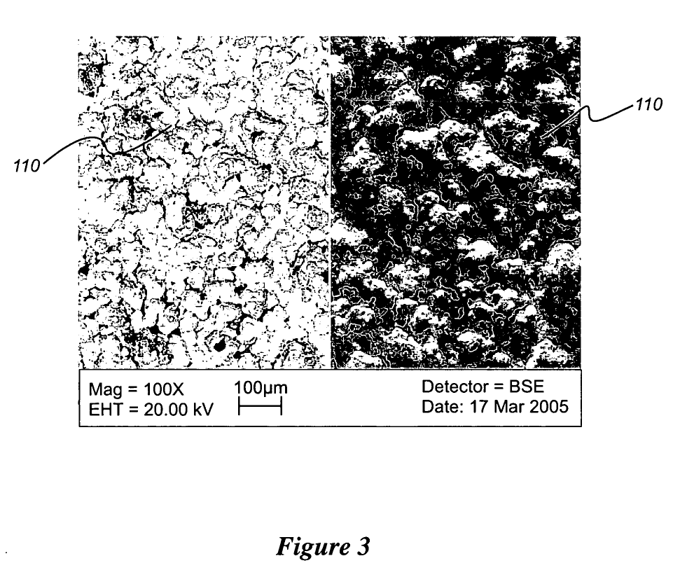

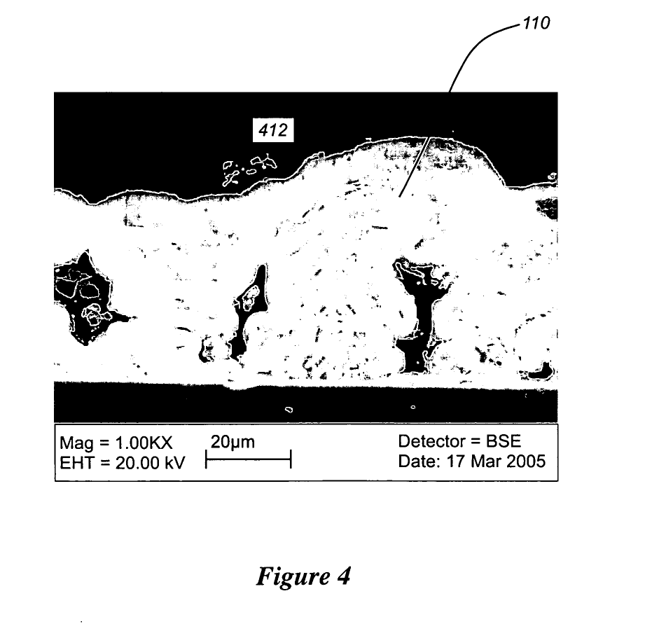

FIG. 3 presents the morphology of the surface. Nodular structures 110 are apparent all over the surface, making it rough. In cross section shown in FIG. 4, it can be seen that the nodules 110 contain MoS₂ particles 412. The elemental distribution map (FIG. 5) reveals that a large amount of particles were co-deposited with the Ni—W deposit.

Multilayer Co-deposition of MoS₂ particles and Ni—W. A 10 micron thick pure Ni—W deposit was formed on a steel plate 614 (FIG. 6) using the Ni—W plating solution described above. The solution in the tank was then removed and without extracting the cathode, a Ni—W solution containing MoS₂ was added. As shown in FIG. 7, the surface morphology shows a similar structure as in the previous case of Ni—W mixed with MoS₂ particles shown in FIG. 4, with nodules 620 containing MoS₂ particles. This sequence produced a bi-layer composite (FIG. 6) with a layer 1612 of Ni—W alternating with a layer of Ni—W+MoS₂ 616.

Co-deposition of MoS₂ particles and Multiple Layers of Ni—W. In this example shown schematically with reference to FIGS. 8 and 9, additional layers were produced. A first layer 812 is Ni—W. A second layer 814 is Ni—W+MoS₂. Third and fourth layers 816, 818 are Ni—W. The whole process was done in the same tank with a rinsing (distilled water) step between the second and third layers to remove MoS₂ particles adhered to the surface.

The surface 803 (FIG. 9) is smoother than in the cases where no top, outer layers of Ni—W have been deposited (as shown in FIG. 7). The effect of smoothening the upper layers is particularly apparent in the cross section view of the deposit (FIG. 9), as no large bumps or protrusions are observed in cross section, especially as compared to FIG. 6 (which is at the same scale).

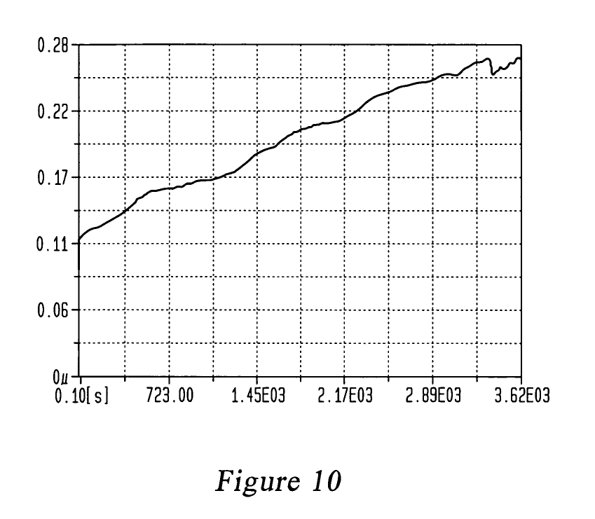

The results of a ball-on-disc test are a shallow sliding path when compared to the previous composite deposits. Flattened nodules are flatter with less space between them for accumulation of debris. The friction coefficient and curve (FIG. 10) is about the same as that obtained with pure Ni—W deposits (shown in FIG. 2). It is believed that, after prolonged sliding, lubricant will be released and slow the wear of the coating. However, the test was not conducted for a sufficient length of time long enough to confirm such behavior.

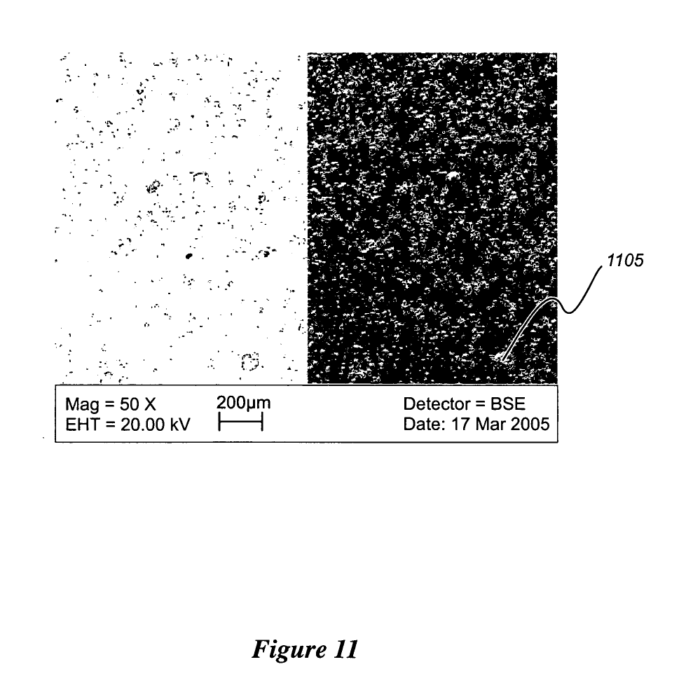

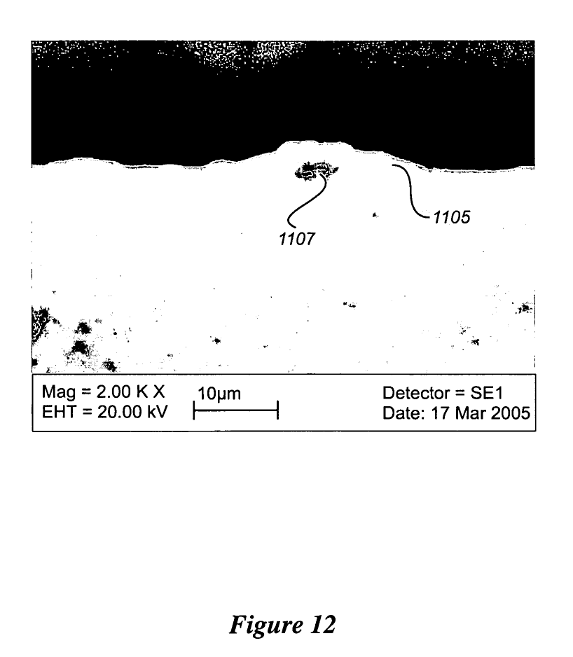

Co-deposition of Ni—W and graphite particles. Graphite particles were suspended in the Ni—W plating solution identified above. When compared to the deposits containing MoS₂, 412 (FIG. 4) the deposits containing graphite have fewer nodules 1105 (FIG. 11). In cross section (FIG. 12) these nodules 1105 contain a few graphite particles 1107. This indicates that graphite is not as easily co-deposited with Ni—W as is MoS₂.

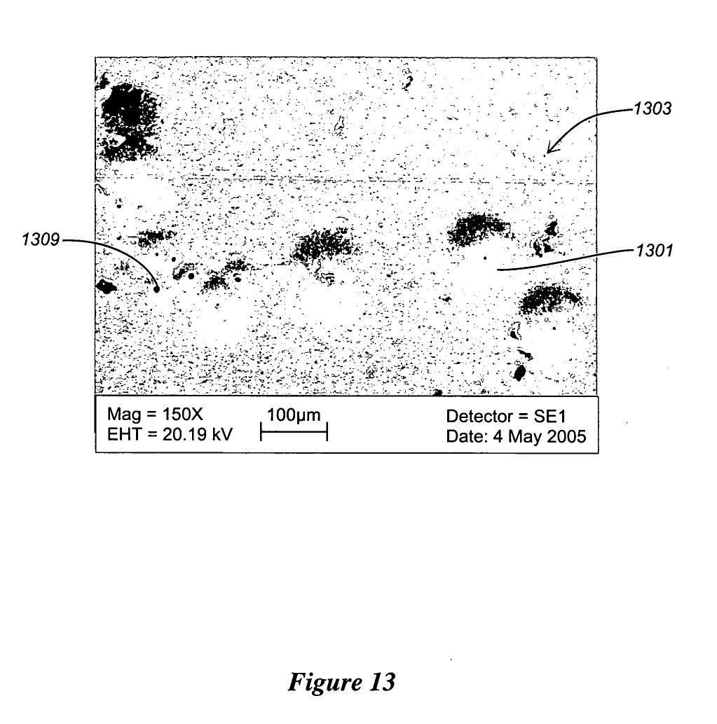

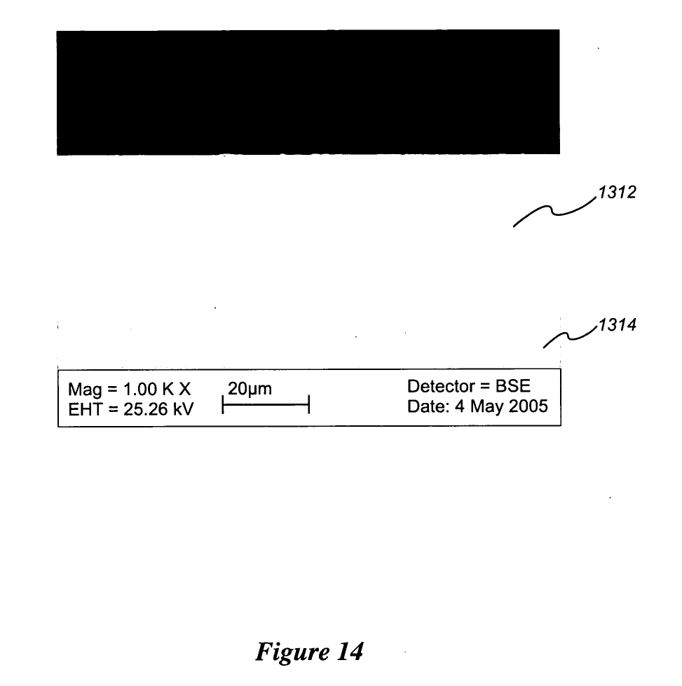

Co-deposition of Ni—W and PTFE (Teflon®) particles. A suspension of nanoparticles of PTFE (Zonyl® TE3667N) available from DuPont deNemours & Company was mixed with the Ni—W solution outlined above and the electrodeposition procedure was followed. As shown in FIG. 13, the deposit surface 1303 was smooth with silk-like reflections 1301 (probably due to a PTFE film) with some pits 1309. In cross section, shown in FIG. 14, it was not possible to detect any PTFE particles by SEM. Only a layer 1312 of Ni—W is shown on a layer 1314 of steel. It is not clear whether or not PTFE was incorporated directly into this layer, or whether any PTFE resides on the upper surface of the coating.

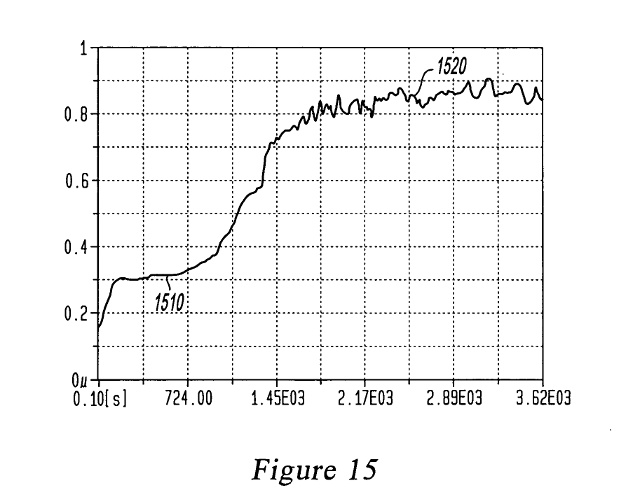

FIG. 15 shows graphically the results of ball-on-disc tests, showing a low friction plateau 1510 at about 0.30, followed by a high friction plateau 520 at about 0.85. The first plateau could be attributed to a PTFE film formed on the cathode by physical adsorption. When this film was removed by the sliding ball, a higher friction coefficient arose.

Anti-galling. Turning now to galling considerations, a nanocrystalline coating was provided for galling protection on 1% Cr steel and carbon steel surfaces. In each of two examples, a metal joint was subject to high friction conditions to illustrate resistance to galling or delay in the appearance of galling.

Ni—W coated discs were prepared to show the wear and galling resistance of the material using a ring-on-disc (RoD) test. The RoD test set up has an automatic cut off when the torque exceeds 10 kg·m. All of the Ni—W samples analyzed in connection herewith reached a higher torque.

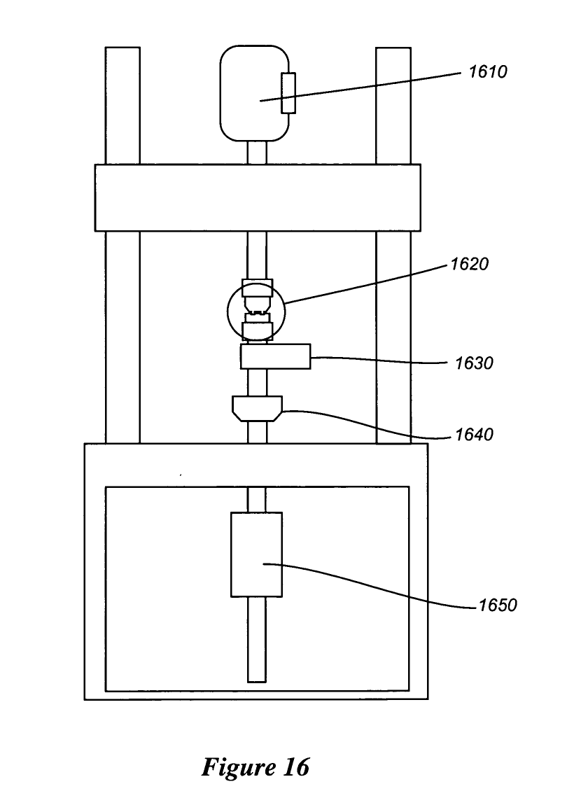

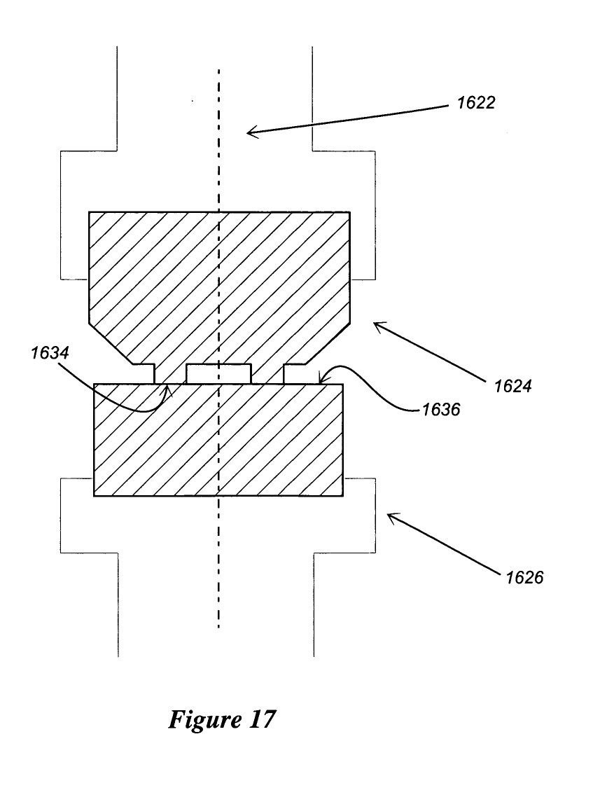

FIGS. 16 and 17 depict schematically a ring-on-disk test layout. An electric motor 1610 applies rotation to a ring-shaped part 1624 (FIG. 17) at a given speed. A ring-and-disk sample set 1620 being evaluated comprises the ring-shaped part 1624 (FIG. 17) and a disc-shaped lower part 1626 (FIG. 17. A torque cell 1630 measures the resultant torque. An axial load cell 1640 measures applied axial load. Finally, a hydraulic piston 1650 applies a controlled axial load along an axis 1622.

In the first example, one planar surface 1636 of disk 1626 was pressed against a planar surface 1634 of the ring 1624 and the ring was rotated under an applied pressure, while the disk 1626 remained fixed. The surface of the ring-shaped part 1624 typically is not chemically treated. The disc-shaped piece 1626 is either pretreated by chemical deposition of manganese phosphate, mechanical treatment of glass peening, or sanding, or not pretreated at all.

Torque over time is monitored. A typical control result without any nanocrystalline anti-galling coating shows the torque increasing with the applied pressure. When the maximum pressure was reached, the torque value decreased and then remained almost constant, indicating a good lubrication process had been achieved. When galling occurred, sharp fluctuations in torque were observed. The time that elapses until the fluctuations begin is considered the characteristic time for the test.

RoD tests involving mating steel components, or those in which phosphate-type coatings are used over steel components, always result in galling if the test is conducted for a long enough period of time at high enough pressures. A typical time to galling might be on the order of a few minutes, up to an hour for applied pressure of 30 kg/mm². However, in experiments where one body was coated with Ni—W based nanocrystalline coatings, no galling was ever observed.

Table 1 shows the results of ring-on-disc tests for various surface treatments on a disc. Direct application of a Ni—W nano-structure coating over steel surfaces results in similar or better performance than applying commonly-used oily liquid lubricants, such as industrial thread compound.

TABLE 1
Ring-on-disk results

| | Average time before | |
|---|---|---|
| Coating applied to steel disk | galling occurs | |
| No lubricant applied | 44 | seconds |
| Metal-free industrial thread | 480 | seconds |
| compound | | |
| Industrial thread compound | 650 | seconds |
| containing copper and zinc | | |
| Commercial thread compound | 959 to 1469 | seconds |
| containing copper, zinc, and | | |
| lead | | |

| | |
|---|---|
| Ni—W nanostructured alloy | No galling observed |
| coating | |

In cases where hard nanocrystalline Ni—W (with −6-8 GPa hardness) was applied to the ring, the counterbody could suffer wear damage after the RoD test against the hard Ni—W coating. However, by changing the grain size of the Ni—W coating, the hardness can be changed. Further RoD examples were performed in which the hardness of an Ni—W deposit was reduced to 3 GPa (similar to the hardness of the counterbody steel) by controlling the electrodeposition process (using the current density as discussed in the Detor patent). In this case abrasion was observed on both sides of the sliding interface (ring and disc) even in the presence of lubricant.

Two additional examples with high hardness (8 GPa) Ni—W nanostructured alloys deposited on both disc and ring surfaces were also carried out. Without lubricant, abrasion damage was observed on both sides. However, using Molykote as a lubricant, no damage was observed even after the maximum torque (10 kgm) was reached.

Ball on disc tests described above showed that when a relatively smooth Ni—W deposit was in contact with a smooth steel ball, no wear of the material was observed (See FIG. 18). The use of leveling agents/additives such as 2-butyne 1,4 diol and mechanical processes are expected to help to smooth out the ridges and roughness of the Ni—W nanocrystalline deposit on RoD samples and thus providing a suitable sliding surface. Such additives are sometimes referred to as leveling agents.

Turning now to corrosion protection, carbon steel samples were plated with a nanostructured Ni—W alloy coating, providing a coating layer with a thickness of about 100 microns. A carbon steel sample was tested in a salt spray (fog) chamber following the ASTM B117 Standard Practice for Operating Salt Spray (Fog) Apparatus. After 1000 hours of testing no corrosion was observed, indicating good corrosion protection.

Nanostructured coated threads provide a method for protecting a metal surface from wear, galling and corrosion, and a composition for protecting a metal surface from wear, galling and corrosion. Such functional coatings and methods of providing the coatings also provide enhanced lubrication. The method and the composition can preferably be applied, for example, to any type of metal thread and any type of metal oil-pipe joint commonly used in the oil industry, in order to confer resistance to galling and corrosion in a simple and economical manner. It could also be applied to other threaded components including but not limited to fasteners, plumbing, or automotive components.

### SUMMARY

An important embodiment of an invention hereof is a threaded object comprising: an article having a threaded metal surface; and, upon the threaded surface, a coating comprising a nano-crystalline metal.

Typically, the coating provides at least one property, as compared to an identical surface free of coating, selected from the group consisting of: corrosion resistance, wear resistance, galling resistance and lubrication. These properties are referred to herein generally as functional properties, and a coating that provides any one such property is referred to herein as a functional coating.

The functionally coated threaded surface may be either a male threaded surface or a female threaded surface, and both male and female threaded surfaces may be provided with such a functional coating.

With one important embodiment, the nano-crystalline metal coating may further include lubricant particles. The lubricant particles may be any appropriate lubricating material, and in particular may be selected from the group consisting essentially of MoS₂, graphite and polytetrafluourethylene.

With related useful embodiments the coating may comprise layers of different nano-crystalline metal formulations. For instance, the metal coating may comprise Ni—W. Or, it may comprise layers of Ni—W alone, and then Ni—W in combination with a lubricating agent.

For many useful embodiments, the article comprise a threaded joint of an oil pipe, or of an assembly through which oil passes, or of an assembly that is used in a messy, oily environment, such as one in which oil is produced, used, processed or handled.

The metal substrate of the threads may be any suitable metal, including any one of aluminum, steel, brass, nickel, copper, stainless steel and alloys thereof.

For other useful embodiments of the article, the coating comprises an alloy deposit having a specified nanocrystalline average grain size. The coating is one that has been provided by depositing on the threaded surface an alloy of a system comprising at least two elements, one of which being most electro-active and at least one of which being a metal. The method by which the coating has been applied comprises the steps of: providing a liquid comprising dissolved species of at least two elements of the system, at least one of which elements is the metal and at least one of which elements is the most electro-active; providing a first electrode and as a second electrode, the article having the threaded surface, in the liquid, coupled to a power supply configured to supply electrical potential having periods of positive polarity and negative polarity at different times; and driving the power supply to achieve the specified grain size deposit at the thread surface of the second electrode, with a non-constant electrical potential having positive polarity and negative polarity at different times, which times and polarities characterize a Polarity Ratio. Polarity Ratio is used as it is used in the Detor document mentioned above.

With still another embodiment, an invention hereof is a method of providing to a threaded surface a functional coating, the method comprising the steps of coating the threaded surface with a nano-crystalline metal coating.

For this method, the threaded surface may comprise a male threaded surface, or a female threaded surfaced, and it is also useful to mate a coated male threaded surface with a coated female metal surface.

A more specific embodiment of a method of an invention hereof involves a coating comprising an alloy deposit having a specified nanocrystalline average grain size. The method of providing the coating comprises depositing on the threaded surface an alloy of a system comprising at least two elements, one of which being most electro-active and at least one of which being a metal. The method of providing a coating comprises the steps of: providing a liquid comprising dissolved species of at least two elements of the system, at least one of which elements is the metal and at least one of which elements is the most electro-active; providing a first electrode and as a second electrode, the article having the threaded surface, in the liquid, coupled to a power supply configured to supply electrical potential having periods of positive polarity and negative polarity at different times; and driving the power supply to achieve the specified grain size deposit at the thread surface of the second electrode, with a non-constant electrical potential having positive polarity and negative polarity at different times, which times and polarities characterize a Polarity Ratio.

With any of the embodiments of methods of inventions hereof, there may also be the step of providing in the liquid lubricating particles. The lubricating particles may be any suitable lubricating material, and especially any material selected from the group consisting essentially of MoS₂, graphite and polytetrafluoroethylene.

It may also be beneficial and a related method of an invention hereof to agitate the liquid while a coating is being deposited.

Finally, a method of an invention hereof may comprise the step of providing to a female threaded surface that mates with the male threaded surface, a functional coating, and a further method comprising the steps of coating the female threaded surface with a nano-crystalline metal coating.

While particular embodiments of the invention have been illustrated and described, it will be apparent to those skilled in the art that various changes and modifications may be made without departing from the spirit and scope of the invention. Furthermore, it is intended that the claims will cover all such modifications that are within the scope of the invention. The methods of coating threaded articles may be used for coating any types of threaded articles, whether or not used in the oil industry, or other dirty or messy environments. The articles and methods of creating them may be advantageously used for threaded joints that are under very high loads, and also that need to be engaged and disengaged many times. They may also be used for threaded joints that withstand less harsh environments, or environments that are harsh in other ways, such as corrosive, chemically active, high friction (such as sandy environments), etc.

This disclosure describes and discloses more than one invention. The inventions are set forth in the claims of this and related documents, not only as filed, but also as developed during prosecution of any patent application based on this disclosure. The inventors intend to claim all of the various inventions to the limits permitted by the prior art, as it is subsequently determined to be. No feature described herein is essential to each invention disclosed herein. Thus, the inventors intend that no features described herein, but not claimed in any particular claim of any patent based on this disclosure, should be incorporated into any such claim.

Some assemblies of hardware, or groups of steps, are referred to herein as an invention. However, this is not an admission that any such assemblies or groups are necessarily patentably distinct inventions, particularly as contemplated by laws and regulations regarding the number of inventions that will be examined in one patent application, or unity of invention. It is intended to be a short way of saying an embodiment of an invention.

An abstract is submitted herewith. It is emphasized that this abstract is being provided to comply with the rule requiring an abstract that will allow examiners and other searchers to quickly ascertain the subject matter of the technical disclosure. It is submitted with the understanding that it will not be used to interpret or limit the scope or meaning of the claims, as promised by the Patent Office's rule.

The foregoing discussion should be understood as illustrative and should not be considered to be limiting in any sense. While the inventions have been particularly shown and described with references to preferred embodiments thereof, it will be understood by those skilled in the art that various changes in form and details may be made therein without departing from the spirit and scope of the inventions as defined by the claims.

The corresponding structures, materials, acts and equivalents of all means or step plus function elements in the claims below are intended to include any structure, material, or acts for performing the functions in combination with other claimed elements as specifically claimed.

What is claimed is:

1. A threaded object comprising:
a. an article having a threaded metal surface;
b. upon the threaded surface, a coating comprising a nano-crystalline metal.

2. The threaded metal object of claim 1, the coating providing at least one property, as compared to an identical surface free of coating, selected from the group consisting of: corrosion resistance, wear resistance, galling resistance and lubrication.

3. The threaded object of claim 2, the threaded surface comprising a male threaded surface.

4. The threaded object of claim 2, the threaded surface comprising a female threaded surface.

5. The threaded object of claim 3, further comprising an article having a female threaded surface, sized and shaped to mate with the male threaded surface, the female threaded surface carrying a nano-cystalline metal coating.

6. The threaded object of claim 2, the nano-crystalline metal coating further comprising lubricant particles.

7. The threaded object of claim 6, the lubricant particles being selected from the group consisting essentially of MoS₂, graphite and polytetrafluourethylene.

8. The threaded object of claim 2, the coating comprising layers of different nano-crystalline metal formulations.

9. The threaded object of claim 2, the metal coating comprising Ni—W.

10. The threaded object of claim 2, the article comprising a threaded joint of an oil pipe.

11. The threaded object of claim 2, the article comprising a threaded joint of an assembly through which oil passes.

12. The threaded object of claim 2, the article comprising an article comprising a metal selected from the group consisting of: aluminum, steel, brass, nickel, copper and stainless steel.

13. The threaded object of claim 2, the coating comprising an alloy deposit having a specified nanocrystalline average grain size, the coating having been provided by depositing on the threaded surface an alloy of a system comprising at least two elements, one of which being most electro-active and at least one of which being a metal, comprising the steps of:
a. providing a liquid comprising dissolved species of at least two elements of the system, at least one of which elements is the metal and at least one of which elements is the most electro-active;
b. providing a first electrode and as a second electrode, the article having the threaded surface, in the liquid, coupled to a power supply configured to supply electrical potential having periods of positive polarity and negative polarity at different times; and
c. driving the power supply to achieve the specified grain size deposit at the thread surface of the second electrode, with a non-constant electrical potential having positive polarity and negative polarity at different times, which times and polarities characterize a Polarity Ratio.

14. A method of providing to a threaded surface a functional coating, the method comprising the steps of coating the threaded surface with a nano-crystalline metal coating.

15. The method of claim 14, the threaded surface comprising a male threaded surface.

16. The method of claim 14, the threaded surface comprising a female threaded surface.

17. The method of claim 14, the coating comprising an alloy deposit having a specified nanocrystalline average grain size, the method of providing a coating comprising depositing on the threaded surface an alloy of a system comprising at least two elements, one of which being most electro-active and at least one of which being a metal, the method of providing a coating comprising the steps of:
a. providing a liquid comprising dissolved species of at least two elements of the system, at least one of which elements is the metal and at least one of which elements is the most electro-active;
b. providing a first electrode and as a second electrode, the article having the threaded surface, in the liquid, coupled to a power supply configured to supply electrical potential having periods of positive polarity and negative polarity at different times; and
c. driving the power supply to achieve the specified grain size deposit at the thread surface of the second electrode, with a non-constant electrical potential having positive polarity and negative polarity at different times, which times and polarities characterize a Polarity Ratio.

18. The method of claim 17, further comprising the step of providing in the liquid lubricating particles.

19. The method of claim 18, the lubricating particles selected from the group consisting essentially of MoS₂, graphite and polytetrafluoroethylene.

20. The method of claim 18, further comprising the step of agitating the liquid while a coating is being deposited.

21. The method of claim 15, further comprising the step of providing to a female threaded surface that mates with the male threaded surface, a functional coating, the method comprising the steps of coating the female threaded surface with a nano-crystalline metal coating.

22. A threaded object comprising:
a. an article having a threaded metal surface;
b. upon the threaded surface, a coating comprising a nano-crystalline metal, the coating comprising an alloy deposit having a specified nanocrystalline average grain size, the coating having been provided by depositing on the threaded surface an alloy of a system comprising at least two elements, one of which being most electro-active and at least one of which being a metal, comprising the steps of:
i. providing a liquid comprising dissolved species of at least two elements of the system, at least one of which elements is the metal and at least one of which elements is the most electro-active;
ii. providing a first electrode and as a second electrode, the article having the threaded surface, in the liquid, coupled to a power supply configured to supply electrical potential having periods of positive polarity and negative polarity at different times; and
iii. driving the power supply to achieve the specified grain size deposit at the thread surface of the second electrode, with a non-constant electrical potential having positive polarity and negative polarity at different times, which times and polarities characterize a Polarity Ratio.
